(19) United States
(12) Patent Application Publication
(10) Pub. No.: US 2013/0005935 A1
(43) Pub. Date: Jan. 3, 2013

(54) Preparing Organopolysiloxanes

(75) Inventor: Gerhard Staiger, Kirchdorf (DE)

(73) Assignee: WACKER CHEMIE AG, Munich (DE)

(21) Appl. No.: 13/528,921

(22) Filed: Jun. 21, 2012

(30) Foreign Application Priority Data
Jul. 1, 2011 (DE) 10 2011 078 544.2

(51) Int. Cl. C08G 77/06; C07F 7/08

(52) U.S. Cl. 528/29; 556/443

(57) ABSTRACT

Organopolysiloxane resins are prepared by reacting tetrachlorosilane with a mixture of 1.0 to 7.0 mol of monohydric alcohol per mol of tetrachlorosilane and 0 to 2 mol of water per mol of tetrachlorosilane to form a partial alkoxylate, followed by the mixing the partial alkoxylate with a water-insoluble organic solvent having a density below 0.95 kg/l and a monofunctional silane of the formula R₃SiX, where R is a monovalent organic moiety or hydrogen and X is a hydrolyzable group, and metering water into this mixture with agitation in amounts of 0.2 to 100 mol of water per mol of silicon component, and following metering of water for hydrolysis, optionally adding a monofunctional silane of the formula R₃SiX or a disiloxane having the formula R₃SiOSiR₃, wherein the amount of monofunctional silane added in the second step is between 0.43 and 2 mol based on 1 mol of tetrachlorosilane.

### CROSS-REFERENCE TO RELATED APPLICATIONS

This application claims priority to German Patent Application No. 10 2011 078 544.2 filed Jul. 1, 2011 which is herein incorporated by reference.

### BACKGROUND OF THE INVENTION

1. Field of the Invention

This invention relates to a multi-step process for preparing organopolysiloxanes by hydrolysis and condensation of chlorosilanes. The process utilizes chlorosilanes that contain tetrachlorosilane and monochlorosilane. The monochlorosilane can also be replaced by its hydrolysis product disiloxane. Owing to the branched structures resulting after hydrolysis and condensation, the organopolysiloxanes of the present invention are thus silicone resins that contain Q units (tetrafunctional siloxy groups) and M units (monofunctional siloxy groups) and are known as MQ resins.

2. Background Art

Three fundamentally different processes for preparing MQ resins are already known.

Preparation by acidification and polymerization of sodium silicates in aqueous solution and subsequent addition of a monofunctional silane or a disiloxane is described for example in U.S. Published Application 2009/093605 (see also the references cited therein). Disadvantages of this process are the poor space-time yields and also the risk of gel formation if critical process parameters are not adhered to. In addition, appreciable amounts of sodium salts are generated.

A further route to MQ resins which is possible in principle (DE4216139) consists of the hydrolysis and condensation of alkyl silicates in the presence of an acid and a monofunctional silane or disiloxane. Disadvantages of this process are the fact that the alkyl silicate has to be prepared additionally from tetrachlorosilane and that the ethanol used therein is lost in the subsequent reaction. This gives rise to additional costs.

DE 10 2005 003 899 (see especially Example 5 and Example 6) describes a process which is more cost-effective in principle and which provides inter alia MQ resins directly from the chlorosilanes. The disadvantage of this process is that delicate control is required in the reaction column; when the separating effect of the column is deficient (even temporarily) gel products are very quick to form and are very difficult to remove.

DE 10 2007 004 838 A1 describes the preparation of silicone resins from chlorosilanes via a partial alkoxylation step. Yet in this process, which represents the prior art closest to the process of the present invention, the use of tetrachlorosilane as a chlorosilane generates appreciable amounts of gel products which are an appreciable aggravation in industrial manufacture.

### SUMMARY OF THE INVENTION

The present invention provides a process for preparing organo-polysiloxanes which comprises:

in a first step, reacting tetrachlorosilane with a mixture of 1.0 to 7.0 mol of monohydric alcohol per mol of tetrachlorosilane and 0 to 2 mol of water, preferably 0.8 mol to 1.2 mol of water, per mol of tetrachlorosilane, the reaction temperature being in a range of 25-60° C. and the exit gas pressure preferably being between 1000 and 1500 hPa, in a second step, mixing the reaction mixture obtained in the first step (“partial alkoxylate”) with a water-insoluble organic solvent having a density of below 0.95 kg/l and also with a monofunctional silane of the formula R₃SiX, where each R independently is a monovalent organic moiety or hydrogen and X is a hydrolyzable group, for example chlorine or OR, with water being metered into this mixture under agitation in amounts of 0.2 to 100 mol of water per mol of silicon component, and in a third step, after metering water for hydrolysis has ended, a monofunctional silane of the formula R₃SiX or a disiloxane having the formula R₃SiOSiR₃, where R and X are each as defined above is optionally added, wherein the amount of monofunctional silane added in the second step is between 0.43 and 2 mol based on 1 mol of tetrachlorosilane. The subject invention process is especially useful for preparing MQ resins which optionally further include additional blocks of RR′SiO_{2/2} units, which does not have the disadvantages that are characteristic of the prior art.

### DETAILED DESCRIPTION OF THE PREFERRED EMBODIMENT(S)

The process of the present invention has a first step in which tetrachlorosilane is reacted with a mixture of preferably 1.0 to 7.0 mol, more preferably 1.2 to 6.4 mol and most preferably 1.5 to 5.0 mol of monohydric alcohol per mol of tetrachlorosilane and preferably 0 to 2 mol of water, more preferably 0.5 mol to 1.5 mol and most preferably 0.8 mol to 1.2 mol of water per mol of tetrachlorosilane. The reaction is preferably carried out by metering silane and an alcohol/water mixture simultaneously into a reaction vessel which preferably already contains a reaction product. The preferred alcohol is ethanol. The reaction temperature is preferably in a range of 25-60° C., more preferably between 30 and 55° C. and most preferably between 35 and 45° C. The temperature can optionally be adjusted to the desired value by external heating. The exit gas pressure is preferably between 800 and 2000 hPa, more preferably between 1000 and 1500 hPa and most preferably between 1100 and 1400 hPa.

A second step comprises mixing the reaction mixture obtained in the first step (“partial alkoxylate”) with a water-insoluble organic solvent preferably having a density of below 0.95 kg/l and also with a monofunctional silane of the formula R₃SiX or a disiloxane of the formula R₃SiOSiR₃, where R is a monovalent organic moiety or hydrogen which may be the same or different in each occurrence and X is a hydrolyzable group, for example chlorine or OR. In the process of the present invention, the molar ratio of the monofunctional silane and tetrachlorosilane is preferably between 0.43 and 2, more preferably between 0.45 and 1.5 and most preferably between 0.5 and 1 and the monofunctional silane preferably is added before water is added. The monofunctional silane can be replaced by the corresponding (half) molar quantity of disiloxane of the formula R₃SiOSiR₃, in which case the amount of the disiloxane added in the second step is preferably between 0.22 and 1, more preferably between 0.225 and 0.75 and most preferably between 0.25 and 0.5 mol, based on 1 mol of tetrachlorosilane.

Optionally, divalent silanes of the formula R₂SiX₂ or their hydrolysis products R′(R₂SiO_{2/2})ₙR′, where R and X are each as defined above, R′ is preferably hydrogen or a monovalent organic moiety, preferably methyl or vinyl, more preferably methyl or hydrogen and n is preferably a number between 3 and 10,000, more preferably 20 to 1000 and most preferably 50 to 500, may be added to this mixture, during or after the water metering, or even before water metering.

This mixture is admixed under agitation with water, preferably in amounts of 0.2 to 100 mol, more preferably 1 to 10 mol and most preferably 2 to 4 mol of water per mol of silicon component, while optionally some or the entire amount of the water has previously been admixed with alcohol in a quantitative alcohol/water ratio of preferably 0.2/0.8 to 0.8/0.2. It is preferable for the first half of the hydrolysis water to be metered in admixture with the same amount of alcohol.

In a third step, completion of the hydrolysis reaction may optionally be followed by adding once more a monofunctional silane of the formula R₃SiX or a disiloxane having the formula R₃SiOSiR₃, where R and X are each as defined above. As a result, the level of residual silanol groups in the end product can be further reduced compared with the prior art. The amount of monofunctional silane used in the third step is preferably in the range of 0-20 mol %, more preferably 0-10 mol %, yet more preferably 0.5-10 mol %, and most preferably 1-5 mol %, based on the amount of tetrachlorosilane. The amount of the disiloxane having the formula R₃SiOSiR₃ is preferably in the range of 0-10 mol %, more preferably 0-5 mol %, yet more preferably 0.25-5 mol %, and most preferably 0-2.5 mol %, 0.5-2.5 mol % based on the amount of tetrachlorosilane.

To end the reaction, an excess of water is used to lower the acid concentration to such an extent that the HCl concentration in the aqueous-alcoholic phase is below 15 wt %. The organic phase is separated off and neutralized and the solvent is distilled off, if desired.

When the resin obtained according to the process of the present invention does not contain any SiH functions (i.e., R is other than hydrogen), alkaline postequilibration may be carried out subsequently in order to raise the molecular weight and further lower the silanol content. For this, the reaction product obtained in the third step is converted in the presence of a base such as sodium hydroxide, potassium hydroxide or tetramethylguanidine and a water-insoluble organic solvent, especially toluene, xylene or trimethylbenzene, at the boiling temperature of the solution and a pressure preferably between 900 to 2000 hPa, more preferably 900 to 1500 hPa and most preferably 900 to 1200 hPa, while water and alcohol are distilled off completely or virtually completely.

Examples of R and R¹ in addition to hydrogen are alkyl moieties such as methyl, ethyl, n-propyl, isopropyl, n-butyl, isobutyl, tert-butyl, n-pentyl, isopentyl, neopentyl, and tert-pentyl, hexyl moieties such as n-hexyl, heptyl moieties such as n-heptyl, octyl moieties such as n-octyl and isooctyl moieties such as 2,2,4-trimethylpentyl, nonyl moieties such as n-nonyl, decyl moieties such as n-decyl, dodecyl moieties such as n-dodecyl; alkenyl moieties such as vinyl, 5-hexenyl, allyl and also acryloyloxyalkyl and methacryloyloxyalkyl; cycloalkyl moieties such as cyclopentyl, cyclohexyl, cycloheptyl and methylcyclohexyl; aryl moieties such as phenyl and naphthyl; alkaryl moieties such as o-tolyl, m-tolyl, p-tolyl, xylyl moieties and ethylphenyl moieties; and aralkyl moieties such as benzyl, α-phenylethyl and β-phenylethyl. R and R¹ are each preferably a hydrocarbonaceous moiety having 1 to 8 carbon atoms, more preferably methyl, vinyl, or methacryloyloxypropyl.

In the process, the total portion of tetrafunctional siloxane units used is preferably from 10 to 70 mol %, more preferably 30 to 65 mol % and most preferably 50 to 65 mol % and the molar ratio of M to Q units is preferably between 3/7 and 2/1 during the water addition in the second step and between 35/65 and 2/1, more preferably between 4/6 and 1/1 following completion of the third step.

Examples of monohydric alcohols useful in the first step of the process according to the present invention are any alcohols that are liquid at a temperature of 20° C. and a pressure of 900 to 1100 hPa, such as methanol, ethanol, n-propanol, i-propanol, butanol, pentanol, hexanol, and heptanol, of which methanol, ethanol and butanol are preferred, and ethanol is particularly preferred.

If desired, the first step of the process according to the present invention may in addition to tetrachlorosilane, water and alcohol also include further feedstocks. Examples of optional further feedstocks are water-insoluble organic solvents, such as toluene, or alkoxysilanes, such as tetraethoxysilane or further chlorosilanes, such as trimethylchlorosilane or vinyldimethylchlorosilane.

In the first step of the process according to the present invention, silane, water, alcohol and optionally further materials are mixed with one another in any desired manner and allowed to react to form tetraalkoxysilane, alkoxychlorosilanes and their hydrolyzates and condensates and also, in gaseous form, hydrogen chloride, alkyl chloride and dialkyl ether. The hydrogen chloride gas generated in the first step can be used directly in other processes, for example together with methanol to prepare chloromethane, which in turn is used in the synthesis of methylchlorosilane. The chlorine can thus be recycled without being emitted into the environment.

The first step can be carried out as a continuous operation or as a batch operation, in which case the batch operation is preferably conducted under agitation. Preferably, however, the first step of the process according to the present invention is carried out as a continuous operation in a loop reactor and more preferably without input of mechanical energy, i.e., only under natural circulation.

In the reaction mixture obtained in the first step, the silicon component consists essentially of chlorine-, hydroxyl- and alkoxy-functional silanes and oligosiloxanes with or without cyclosiloxanes. The reaction mixture further contains water, alcohol, hydrogen chloride and small amounts of alkyl chloride and of dialkyl ether with or without further materials.

In the context of the present invention, unless otherwise stated in the particular instance, all amount and percentage recitations are by weight and all percentages are based on the overall weight, all temperatures are 20° C. and all pressures are in the range from 900 to 1100 hPa (1.013 bar (absolute)). Viscosities are all determined at 25° C. In the context of the present invention, densities are at a temperature of 20° C. and the pressure of the ambient atmosphere, i.e., 900 to 1100 hPa.

Water-insoluble organic solvents for the purposes of the present invention are solvents where the solubility at 25° C. and the pressure of the ambient atmosphere, i.e., 900 to 1100 hPa, is below 1 g of solvent/100 g of water.

Examples of water-insoluble organic solvents used in the process of the present invention are saturated hydrocarbons such as pentane, hexane, heptane or octane and also branched isomers thereof, and aromatic hydrocarbons, such as benzene, toluene and xylenes, in which case toluene is preferably concerned, and mixtures of saturated hydrocarbons with aromatic hydrocarbons.

The second step of the process according to the present invention preferably utilizes a water-insoluble organic solvent. The amount of solvent used is in the range of from 0.2 to 100 times, preferably from 0.5 to 5 times and more preferably from 0.7 to 3 times the amount of the silicon components used.

In the process of the present invention, a monofunctional silane of the formula R₃SiX or a disiloxane of the formula R₃SiOSiR₃ is added in a sufficient amount before starting the hydrolysis reaction. This addition can also take place during the first step. The amounts involved are preferably 0.43 to 2 mol of monofunctional silane or 0.22 to 1 mol of disiloxane, more preferably 0.45 to 1.5 mol of monofunctional silane or 0.225 to 0.75 mol of disiloxane and even more preferably 0.5 to 1 mol of monofunctional silane or 0.25 to 0.5 mol of disiloxane based on 1 mol of tetrachlorosilane used in the first step. The monofunctional silane is preferably a chlorosilane or an alkoxysilane, where R is as defined above.

It is preferable for the process of the present invention to utilize a monoalkylsilane preferably in amounts of 0-20 mol %, more preferably 0-10 mol %, while it is particularly preferable for no monoalkylsilane to be used.

In one preferred embodiment of the process according to the present invention, the second step comprises optionally mixing the reaction mixture obtained in the first step with toluene after adding the monofunctional silane and metering water over a defined period, while the mixing operation is performed via input of mechanical energy using a stirrer, for example.

If desired, further materials can also be used in the second step of the process according to the present invention. Examples of further materials optionally used are in particular polysiloxanes of the formula R′O(R₂SiO)ₙR′, where R′ has the abovementioned meanings of R or is an R₃SiO group, and n is preferably a number in the range of 3 to 10,000, more preferably 5 to 5000 and most preferably 50 to 5000. Hydrogen and trimethylsilyl are particularly preferred for R′.

When further materials are used in the second step, the amounts involved preferably range from 0.01 to 1000 parts by weight and more preferably from 10 to 50 parts by weight, based on 100 parts by weight of the silicon component used in the first step.

Acrylate- or methacrylate-functional silanes are preferred as further materials that can be added in the second step. Examples are methacryloyloxypropyltrimethoxysilane, methacryloyloxypropyldimethylmethoxysilane and acryloyloxypropyltrimethoxysilane. These are preferably used in an amount of 1-20 mol %, more preferably 2-15 mol %, yet more preferably in an amount of 5-15 mol %, and most preferably 5-10 mol %, based on tetrachlorosilane.

In a further particularly preferred embodiment of the process according to the present invention, the water used in the second step is metered downwardly into the reactor under simultaneous agitation.

The second step of the process according to the present invention is preferably carried out at a temperature of 0 to 100° C., more preferably 20 to 80° C., and most preferably 20 to 60° C., and at a pressure of preferably 500 to 2000 hPa, more preferably 600 to 1500 hPa, and most preferably 800 to 1400 hPa.

In the third step of the process according to the present invention, the hydrolysis/condensation reaction is ended in a known manner, for example by diluting with excess water or neutralizing the reaction mixture with aqueous sodium hydroxide solution, optionally after further addition of a monofunctional silane of the formula R₃SiX or of a disiloxane of the formula R₃SiOSiR₃, where R and X are each as defined above.

The third step of the process according to the present invention comprises separating the possibly solvent-containing siloxane phase from the aqueous-alcoholic hydrogen chloride phase. This can be done by methods known to a person skilled in the art, for example by allowing the reaction mixture to stand for 5 to 60 minutes until the phases have separated. The phases are then separately discharged and worked up.

The siloxane phase thus obtained can then be worked up by any methods known per se, for example neutralization, filtration and removal of all volatiles, preferably by distillation. The volatiles are essentially the water-insoluble organic solvent having a density of below 0.95 kg/l. It is further possible, for example, to increase the concentration by removing the solvent from the siloxane phase, for instance by distillation in a thin film evaporator, to thereby prepare organopolysiloxane solutions or else to remove the solvent entirely and thus obtain solvent-free siloxanes.

The process of the present invention provides siloxane resins which in addition to M and Q units can contain a multiplicity of other structural units in a reproducible manner with defined properties. Preferably, alkenyl moieties and Si-hydrogen moieties come into consideration as further structural units.

The process of the present invention also provides siloxane resins that are assembled from blocks of MQ units and blocks of D units (“PDMS” blocks). These MQ-PDMS block copolymers are used, for example, in silicone adhesive resins (see for example EP0816463) or in controlled release additives (CRAs) in dehesive coatings. PDMS in this context is a polysiloxane of the formula R(R₂SiO)ₙR, where R and n are each as defined above.

PDMS block length and composition in the copolymer is determined by the PDMS component used in the second step (“hydrolysis step”) of the process. Short-chain PDMS components give short PDMS blocks in the copolymer, while long PDMS components lead to longer PDMS blocks under identical reaction conditions. The timing of the addition in the course of the second reaction step is also important: When the PDMS component is added before or at the start of addition of the hydrolysis water to the reaction medium, the block of D units becomes equilibrated into smaller chains than when the PDMS component is only added at the end of the hydrolysis shortly before the reaction is discontinued by adding excess water.

The PDMS component can consist of RHSiO units to an extent of from 0 to 100%, in accordance with the formula (R₂SiO)ₙ.

A fourth step may be carried out whereby an alkaline compound is added to cause the polyorganosiloxane resin, which is in the form of an organic solution and optionally contains PDMS blocks, to become adjusted to a pH above 7 and condensed by removing an alcohol/water/solvent mixture. The product obtained may further be neutralized by adding an acid and/or acid-yielding compound. Subsequently, it is optionally possible to remove water still present and some of the solvent and also separate off insolubles. The condensation is preferably carried out in the pH range from 8 to 14, more preferably from 8 to 12 and most preferably from 8 to 10 and at reflux temperatures of the organic solvent, toluene, xylene or trimethylbenzene, for example, in the range between 100 to 180° C., preferably 120 to 180° C., and more preferably 140 to 160° C. and at a pressure between 900 to 2000 hPa, preferably 900 to 1500 hPa, and more preferably 900 to 1300 hPa. Useful catalysts include any compounds known for this reaction, preference being given to alkali metal hydroxides such as sodium hydroxide or potassium hydroxide, or amino compounds, for example tetramethylguanidine. Hydrochloric acid is typically used for subsequent neutralization of the basic mixture.

This fourth step may be modified to the effect that amino-functional silanes are added to the reaction mixture. These silanes become integrated into the resin structure as amino-functional siloxane units under the reaction conditions described above. These amino-functional silanes are preferably used in amounts of 0.5-25 wt %, more preferably 1-20 wt %, and most preferably 5-15 wt %, based on the polyorganosiloxane resin. Examples of amino-functional silanes are N-(2-aminoethyl)-N′-[3-(trimethoxysilyl)propyl]ethylenediamine, N-(2-aminoethyl)-N′-[3-(triethoxysilyl)-propyl]ethylenediamine, and 3-(triethoxysilyl)propylamine.

Advantageously, the neutralization is followed by further azeotropic removal of water and removal of insolubles, usually salts formed by the neutralization. The resin solution can finally be solvent adjusted to the desired concentration and then is ready to use. Solvent-free liquid resins are obtainable provided the MQ and/or PDMS blocks are chosen in a suitable manner.

The organopolysiloxanes obtained according to the present invention can be solid or liquid at 20° C. and a pressure of 900 to 1100 hPa and have an average molecular weight, as measured against polystyrene standards, of preferably 200 to 100,000 g/mol, and more preferably 800 to 20,000 g/mol.

The process of the present invention is the first to provide MQ resins having a very narrow molecular weight distribution on an industrial basis, i.e., without additional methods of fractionation such as chromatography in supercritical carbon dioxide. They are accordingly advantageous for further processing into Si-pressure sensitive adhesives (see EP0255226). The polydispersity (Mw/Mn) of the molecular weight distribution obtained after the fourth step (alkaline postcondensation) is preferably below 2.0.

The organopolysiloxanes obtained according to the present invention are preferably organopolysiloxanes of the formula

[(R₂SiO)ₙ]ₐ[R₃SiO_{1/2}]_{b}[R¹O_{1/2}]_{d}[HO_{1/2}]ₑ[SiO_{4/2}]_{4-b-c-d}

where
R is hydrogen, methyl, isooctyl or vinyl,
R¹ is methyl, ethyl or butyl,
n=2-10,000, a=0-2, b=1.4-2.1, d=0-0.5, e=0-0.5, subject to the proviso that 1.4<b+c+d.

The organopolysiloxanes obtained according to the present invention can be used for any purpose for which MQ resins are useful. For instance, the organopolysiloxane resins/concentrates of the present invention can be used as foam stabilizers, as admixture to antifoams, toners, and painting and coating systems such as paper-coating compositions for example. They can also be used in place of hydrophobicized colloidal silica as fillers in plastics, especially silicone rubber.

The process of the present invention has the advantage that it is simple to carry out and provides MQ resins in a high yield in a very cost-effective manner. The process of the present invention has the further advantage that the optionally used water-insoluble organic solvent, the hydrogen chloride and also the alcohol are simple to recover. The process of the present invention provides organopolysiloxanes that have a long shelf life and are very low in chloride content.

In the examples which follow, all parts and percentages are by weight, unless otherwise stated, and are carried out at a pressure of the ambient atmosphere, i.e., at about 1000 hPa, and at room temperature, i.e., about 20° C. or a temperature which is the autogenous result of adding the reactants together at room temperature without additional heating or cooling. Viscosities reported in the examples shall all relate to a temperature of 25° C.

### EXAMPLE 1

A 3-neck flask fitted with a stirrer, an intensive reflux condenser, the cooling medium of which is cooled down to −20° C., and also two feed vessels is simultaneously charged in the course of 15 min under agitation with 236 g of tetrachlorosilane and 291 g of ethanol (having a water content of 8 wt %). The released HCl off-gases via the condenser (−20° C.), and condensables are returned into the reaction medium, which heats up to 38° C. during the alkoxylation. Off-gassing is allowed to continue for a further 10 min, at which point 300 g of toluene, 80 g of trimethylchlorosilane and also 100 g of polydimethylsiloxane having a chain length of about 60 siloxane units and silanol end groups are added.

This is followed by the addition, during 35 min, of a mixture of 42 g of ethanol and 42 g of water, followed by 44 g of water added during a further 15 min. Following a post-reaction time of 30 min 13.5 g of trimethylchlorosilane are added, followed by 200 g of water after a further 5 min. The organic phase of the two-phase reaction mixture is separated off, mixed with activated carbon (0.25 wt %), sodium bicarbonate (0.4 wt %) and also filter aid, and filtered. The filtrate is freed of solvent in a rotary evaporator at 175° C./10 mbar to obtain 220 g of colorless liquid having the composition M(0.61)QD(0.88) consisting of a molecular fraction of 0.61 mol of trimethylsiloxy groups M, 1 mol of siloxy groups Q and 0.88 mol of dimethylsiloxy groups D, having a viscosity of 130 cSt. Mw 2400 g/mol; Mn 1600 g/mol; chain length of D blocks: about 3 dimethylsiloxy units; ratio of M/Q units 0.6.

### EXAMPLE 2

A 3-neck flask fitted with a stirrer, an intensive reflux condenser, the cooling medium of which is cooled down to −20° C., and also two feed vessels is simultaneously charged in the course of 15 min under agitation with 236 g of tetrachlorosilane and 291 g of ethanol (having a water content of 8 wt %). Released HCl off-gases via the condenser (−20° C.), and condensables are returned into the reaction medium, which heats up to 38° C. during the alkoxylation. Off-gassing is allowed to continue for a further 10 min, at which point 300 g of toluene and also 80 g of trimethylchlorosilane are added.

This is followed by the addition, during 25 min, of a mixture of 42 g of ethanol and 42 g of water, followed by 44 g of water added during a further 25 min, and then 100 g of polydimethylsiloxane having a chain length of about 60 siloxane units and silanol end groups. Following a post-reaction time of 5 min a mixture of 6.75 g of trimethylchlorosilane and 7.5 g of vinyldimethylchlorosilane is added. After a further reaction time of 15 min, the hydrolysis as well as condensation reaction is discontinued by rapid addition of 200 g of water. The organic phase of the two-phase reaction mixture is separated off, mixed with activated carbon (0.25 wt %), sodium bicarbonate (0.4 wt %) and also filter aid, and filtered. The filtrate is freed of solvent in a rotary evaporator at 175° C./10 mbar to obtain 224 g of colorless liquid having the composition M(0.59)Mvi(0.033)QD(0.93) and a viscosity of 365 mPa·s (25° C.), Mw 4600 g/mol; Mn 2300 g/mol; chain length of D blocks: about 36 dimethylsiloxy units.

### EXAMPLE 3

A 3-neck flask fitted with a stirrer, an intensive reflux condenser, the cooling medium of which is cooled down to −20° C., and also two feed vessels is simultaneously charged in the course of 15 min under agitation with 236 g of tetrachlorosilane and 291 g of ethanol (having a water content of 8 wt %). The released HCl off-gases via the condenser (−20° C.), and condensables are returned into the reaction medium, which heats up to 50° C. during the alkoxylation. Off-gassing is allowed to continue for a further 10 min, at which point 300 g of toluene and also 90 g of trimethylchlorosilane are added.

A mixture of 42 g of ethanol and 42 g of water is subsequently added during 25 min, followed by 44 g of water during a further 25 min. This is followed by the addition of 3.3 g of trimethylchlorosilane. Following a reaction time of 30 min at 40° C. the reaction is discontinued by adding 200 g of water and the phases which are formed are separated. The organic phase is admixed with 0.25 wt % of activated carbon, 0.4 wt % of sodium bicarbonate and also 0.33 wt % of filter aid, filtered, and the filtrate is evaporated up to a vacuum of 10 mbar, 175° C. during 5 min to obtain 143 g of viscous silicone resin of the composition M(0.71)Q having a viscosity of 512,000 mPa·s (40° C.), Mw 1600 g/mol, Mn 1300 g/mol.

### EXAMPLE 4

### Alkaline Aftertreatment of Example 3

100 g of silicone resin from Example 3 are dissolved in 50 g of xylene, the solution is admixed with 0.4 g of 25% strength aqueous KOH solution and subsequently evaporated under atmospheric pressure at a temperature up to 175° C. and left at 175° C. for 30 min. The residue is subsequently dissolved in 50 g of xylene, admixed first with 2 g of 20% strength aqueous HCl solution, then with 0.25 wt % of activated carbon, 0.4 wt % of sodium bicarbonate and also 0.33 wt % of filter aid, and filtered. The solvent is removed by evaporating to obtain 95 g of colorless solid material. The MQ resin of the composition M(0.7)Q is shown by gel permeation chromatography to have the following molecular weights: Mw 4400 g/mol, Mn 2400 g/mol.

### EXAMPLE 5

A 3-neck flask fitted with a stirrer, an intensive reflux condenser, the cooling medium of which is cooled down to −20° C., and also two feed vessels is simultaneously charged in the course of 15 min under agitation with 236 g of tetrachlorosilane and 291 g of ethanol (having a water content of 8 wt %). The released HCl off-gases via the condenser (−20° C.), and condensables are returned into the reaction medium which heats up to 50° C. during the alkoxylation. Off-gassing is allowed to continue for a further 10 min, at which point 300 g of toluene and also 80 g of trimethylchlorosilane are added.

A mixture of 42 g of ethanol and 42 g of water is subsequently added during 25 min, followed by 44 g of water during a further 25 min. The reaction mixture is allowed to post-react for 30 min, at which point 15 g of vinyldimethylchlorosilane are added. Following a reaction time of 15 min (50° C.) 200 g of water are added and the phases which form are separated. The organic phase is mixed with activated carbon (0.25 wt %), sodium bicarbonate (0.4 wt %) and also filter aid, and filtered. The filtrate is freed of solvent in a rotary evaporator at 175° C./10 mbar to obtain 148 g of viscous silicone resin of the composition (NMR) M(0.78)Mvi(0.14)Q and the following molecular weights (GPC): Mw 800 g/mol, Mn 700 g/mol.

### EXAMPLE 6

### Alkaline Aftertreatment of Product of Example 5

100 g of silicone resin from Example 5 are dissolved in 50 g of xylene, the solution is admixed with 0.4 g of 25% strength aqueous KOH solution and subsequently evaporated under atmospheric pressure at a temperature up to 175° C. and left at 175° C. for 30 min. The residue is subsequently dissolved in 50 g of xylene, admixed first with 2 g of 20% strength aqueous HCl solution, then with 0.25 wt % of activated carbon, 0.4 wt % of sodium bicarbonate and also 0.33 wt % of filter aid, and filtered. The solvent is removed by evaporating to obtain 93 g of colorless solid material. This solid is shown by NMR analysis to have a composition (NMR) M(0.75)Mvi(0.15)Q and by GPC to have the following molecular weights: Mw 4200; Mn 2600.

### EXAMPLE 7

A 3-neck flask fitted with a stirrer, an intensive reflux condenser, the cooling medium of which is cooled down to −20° C., and also two feed vessels is simultaneously charged in the course of 15 min under agitation with 236 g of tetrachlorosilane and 291 g of ethanol (having a water content of 8 wt %). The released HCl off-gases via the condenser (−20° C.), and condensables are returned into the reaction medium which heats up to 38° C. during the alkoxylation. Off-gassing is allowed to continue for a further 5 min, at which point 300 g of toluene, 20 g of 3-methacryloyloxypropyltrimethoxysilane (Geniosil® GF31) and also 80 g of trimethylchlorosilane are added.

A mixture of 22 g of ethanol and 45 g of water is then added during 10 min, followed by 66 g of water added during a further 10 min. This is followed by the addition of 13.5 g of trimethylchlorosilane and 100 g of polydimethylsiloxane having a chain length of about 60 siloxane units and silanol end groups. Following a reaction time of 30 min (40° C.) 200 g of water are added and the phases which form are separated. The organic phase is mixed with activated carbon (0.25 wt %), sodium bicarbonate (0.4 wt %) and also filter aid, and filtered. The filtrate is admixed with 0.1 wt % of BHT and freed of solvent in a rotary evaporator at 175° C./10 mbar to obtain 253 g of methacryloyl-functional MQ resin of the composition (NMR) M(0.63)D(0.95)T′(0.056)Q, where T′ is the methacryloyloxypropylsiloxy moiety, the MQ resin having the following molecular weights according to GPC: Mw 4600 g/mol, Mn 2200 g/mol.

### EXAMPLE 8

A 3-neck flask fitted with a stirrer, an intensive reflux condenser, the cooling medium of which is cooled down to −20° C., and also two feed vessels is simultaneously charged in the course of 15 min under agitation with 236 g of tetrachlorosilane and 291 g of ethanol (having a water content of 8 wt %). The released HCl off-gases via the condenser (−20° C.), and condensables are returned into the reaction medium which heats up to 48° C. during the alkoxylation. Off-gassing is allowed to continue for a further 10 min, at which point 300 g of toluene, and also 120 g of trimethylchlorosilane are added and the mixture is stirred for a further 10 min without heat input (temperature 32° C.). A mixture of 45 g of ethanol and 22 g of water is subsequently added during 10 min, followed by 65 g of water during a further 10 min. Thereafter 400 g of polydimethylsiloxane having a chain length of about 60 siloxane units and silanol end groups are added. Following a reaction time of 30 min 13.5 g of trimethylchlorosilane and also a further 400 g of polydimethylsiloxane are added. After a further 5 min the reaction is terminated by addition of 200 g of water. The organic phase of the two-phase reaction mixture is separated off, mixed with activated carbon (0.25 wt %), sodium bicarbonate (0.4 wt %) and also filter aid, and filtered. The filtrate is freed of solvent in a rotary evaporator at 175° C./10 mbar to obtain 880 g of colorless liquid having the composition M(0.88)QD(7.5). Mw 7900 g/mol; Mn 3700 g/mol.

### EXAMPLE 9

300 g of silicone resin from Example 8 are dissolved in 180 g of toluene together with 30 g of Geniosil® GF 95 and 0.3 g of 25% strength aqueous KOH solution. The solution is heated under atmospheric pressure at 125° C. for 30 min during which about 100 ml of liquid distill off. The residue is subsequently taken up in 100 g of toluene, and the mixture is admixed with 0.25 wt % of activated carbon, 0.4 wt % of sodium bicarbonate and also 0.33 wt % of filter aid, and filtered. The solvent is evaporated off (at up to 175° C., 10 mbar, 5 min) out of the filtrate to obtain 288 g of colorless liquid which is shown by NMR analysis to have the following composition: M(0.85)QD(0.72)DDAEAP(0.21), where DDAEAP is the dimethyl-aminoethyleneaminopropylmethylsiloxy group. The following molecular weights were obtained according to GPC: Mw 6500; Mn 2800.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. It is understood that ranges delineated by the word “between” include the end values thereof

What is claimed is:

1. A process for preparing organopolysiloxanes comprising:
a) in a first step, reacting tetrachlorosilane with a mixture of 1.0 to 7.0 mol of monohydric alcohol per mol of tetrachlorosilane and 0 to 2 mol of water per mol of tetrachlorosilane to form a partial alkoxylate,
b) in a second step, mixing the partial alkoxylate with a water-insoluble organic solvent having a density of below 0.95 kg/l and also with a monofunctional silane of the formula R₃SiX, where R each individually is a monovalent organic moiety or hydrogen and X is a hydrolyzable group, and metering water into this mixture in an amount of 0.2 to 100 mol of water per mol of silicon component with agitation, and
c) in a third step, wherein after metering of water for hydrolysis has ended, optionally adding a monofunctional silane of the formula R₃SiX or a disiloxane of the formula R₃SiOSiR₃, where R and X are each as defined above,
wherein the amount of monofunctional silane added in the second step is between 0.43 and 2 mol based on 1 mol of tetrachlorosilane.

2. The process of claim 1, wherein in the second step, the partial alkoxylate is mixed with a water-insoluble organic solvent having a density of below 0.95 kg/l and also with a disiloxane of the formula R₃SiOSiR₃, where R each individually is a monovalent organic moiety or hydrogen, water is metered in amounts of 0.2 to 100 mol of water per mol of silicon component with agitation, and the amount of disiloxane added in the second step is between 0.22 and 1 mol based on 1 mol of tetrachlorosilane.

3. The process claim 1, wherein divalent silanes of the formula R₂SiX₂ or their hydrolysis products R′(R₂SiO_{2/2})ₙR′, where R and X are each as defined above, R′ is a monovalent organic moiety or hydrogen, and n is a number between 2 and 10,000, are also added in the second step, before, during or after completion of metering of water.

4. The process claim 2, wherein divalent silanes of the formula R₂SiX₂ or their hydrolysis products R′(R₂SiO_{2/2})ₙR′, where R and X are each as defined above, R′ is a monovalent organic moiety or hydrogen, and n is a number between 2 and 10,000, are also added in the second step, before, during or after completion of metering of water.

5. The process of claim 1, wherein an acrylate- or methacrylate-functional silane in an amount of 1-20 mol %, based on tetrachlorosilane used in the first step is added in the second step.

6. The process of claim 2, wherein an acrylate- or methacrylate-functional silane in an amount of 1-20 mol %, based on tetrachlorosilane used in the first step is added in the second step.

7. The process of claim 3, wherein an acrylate- or methacrylate-functional silane in an amount of 1-20 mol %, based on tetrachlorosilane used in the first step is added in the second step.

8. The process of claim 4, wherein an acrylate- or methacrylate-functional silane in an amount of 1-20 mol %, based on tetrachlorosilane used in the first step is added in the second step.

9. The process of claim 1, wherein a reaction product obtained in the third step is further reacted, at a pH of 8 to 14 in the presence of a base and of a water-insoluble organic solvent at a temperature of 120-180° C. and a pressure between 900 and 2000 hPa, while water and alcohol are removed by distillation.

10. The process of claim 2, wherein a reaction product obtained in the third step is further reacted, at a pH of 8 to 14 in the presence of a base and of a water-insoluble organic solvent at a temperature of 120-180° C. and a pressure between 900 and 2000 hPa, while water and alcohol are removed by distillation.

11. The process of claim 3, wherein a reaction product obtained in the third step is further reacted, at a pH of 8 to 14 in the presence of a base and of a water-insoluble organic solvent at a temperature of 120-180° C. and a pressure between 900 and 2000 hPa, while water and alcohol are removed by distillation.

12. The process of claim 4, wherein a reaction product obtained in the third step is further reacted, at a pH of 8 to 14 in the presence of a base and of a water-insoluble organic solvent at a temperature of 120-180° C. and a pressure between 900 and 2000 hPa, while water and alcohol are removed by distillation.

13. The process of claim 9, wherein the reaction product has a polydispersity below 2.

14. The process of claim 5, wherein the reaction product obtained in the third step is further reacted in the presence of a base and also an amino-functional silane used in amounts of 0.5-25 wt %, based on the weight of a polyorganosiloxane resin obtained in the third step.
